(19) United States
(12) Patent Application Publication
(10) Pub. No.: US 2017/0270031 A1
(43) Pub. Date: Sep. 21, 2017

(54) INFORMATION PROCESSING APPARATUS, TEST EXECUTION METHOD, AND COMPUTER-READABLE RECORDING MEDIUM

(71) Applicant: FUJITSU LIMITED, Kawasaki-shi (JP)

(72) Inventors: Atsuji Sekiguchi, Kawasaki (JP); Koki Kato, Yokohama (JP); Satoshi Munakata, Kawasaki (JP); Takeshi Yasuie, Kawasaki (JP)

(73) Assignee: FUJITSU LIMITED, Kawasaki-shi (JP)

(21) Appl. No.: 15/423,992

(22) Filed: Feb. 3, 2017

(30) Foreign Application Priority Data
Mar. 15, 2016 (JP) 2016-051626

(51) Int. Cl. G06F 11/36

(52) U.S. Cl. CPC G06F 11/3664

(57) ABSTRACT

A test control device stores therein, for each user who revises a system that includes a plurality of components, a use configuration table in which the type of the components that are used in revision is associated with the connection relation between the components that are used in the revision. When the test control device receives a request from a terminal device, the test control device specifies, on the basis of the use configuration table associated with the user of the terminal device, the type of the component that serves as the transfer destination of the request. When the server device associated with the specified type is running, the test control device transfers the request to the server device and transfers, when the server device has not been started up, the request to the started up server device after starting up the subject server device.

### CROSS-REFERENCE TO RELATED APPLICATION

This application is based upon and claims the benefit of priority of the prior Japanese Patent Application No. 2016-051626, filed on Mar. 15, 2016, the entire contents of which are incorporated herein by reference.

### FIELD

The embodiments discussed herein are related to an information processing apparatus, a test execution method, and a computer-readable recording medium.

### BACKGROUND

In recent years, a service using an information and communication technology (ICT) system constituted from a plurality of components, such as Web components, application (AP) components, database (DB) components, and the like, is increased. When compared with conventional physical servers or virtual machines (VMs), these components are increasingly operated by using a container technology in which an amount of disk and memory is small and the startup time is short.

The service using such components is sometimes developed by a team of a plurality of people and frequently repeats revision due to addition or improvement of the functions. Furthermore, even if the revision is frequently performed, a test environment is usually prepared in order to avoid stopping the service and a test is usually performed by using previously created test codes. For example, there is a known technique that prepares one or a plurality of common test systems or there is a known technique that prepares a test system for each developer.

Patent Document 1: Japanese Laid-open Patent Publication No. 2010-113381

Patent Document 2: Japanese Laid-open Patent Publication No. 04-195436

However, the technology described above uses a large number of resources and is not convenient. For example, in a case where the common test system is used, the number of resources is small; however, because a plurality of members is not able to use the resources at the same time, convenience is low and frequent revision is impossible. Furthermore, with the technology that prepares the test system for each developer, the number of resources to be used is increased and the cost is increased.

### SUMMARY

According to an aspect of an embodiment, an information processing apparatus includes a memory configured to store therein, for each user who revises a system that includes a plurality of components, a use configuration table in which the type of the components that are used in revision is associated with the connection relation between the components that are used in the revision; and a processor coupled to the memory and the processor configured to: specify, when a request is received from a terminal device, on the basis of the use configuration table associated with the user of the terminal device, the type of the component that serves as the transfer destination of the request; and transfer, when a server device associated with the specified type is running, the request to the server device and transfer, when the server device has not been started up, after starting up the subject server device, the request to the started up server device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating a system according to a first embodiment;

FIG. 2 is a functional block diagram illustrating the functional configuration of a test control device according to the first embodiment;

FIG. 3 is a schematic diagram illustrating an example of information stored in a use configuration table;

FIG. 4 is a schematic diagram illustrating an example of information stored in a container information table;

FIG. 5 is a schematic diagram illustrating an example of information stored in a flow control table;

FIG. 6 is a schematic diagram illustrating deletion of a container;

FIG. 7 is a flowchart illustrating the flow of a container start up process and a request transfer process according to the first embodiment;

FIG. 8 is a schematic diagram illustrating revision of the components according to the first embodiment;

FIG. 9 is a functional block diagram illustrating the functional configuration of a test control device according to a second embodiment;

FIG. 10 is a schematic diagram illustrating an example of information stored in an exclusive container type table according to the second embodiment;

FIG. 11 is a schematic diagram illustrating an example of information stored in a flow control table according to the second embodiment;

FIG. 12 is a flowchart illustrating the flow of a container startup process and a request transfer process according to the second embodiment;

FIG. 13 is a schematic diagram illustrating a test environment using exclusive containers according to the second embodiment;

FIG. 14 is a schematic diagram illustrating estimation of use containers according to the third embodiment;

FIG. 15 is a schematic diagram illustrating estimation of the exclusive containers according to the third embodiment;

FIG. 16 is a schematic diagram illustrating estimation of the exclusive containers according to the third embodiment;

FIG. 17 is a flowchart illustrating the flow of a confirmation process of the test case according to the third embodiment;

FIG. 18 is a flowchart illustrating an estimation process of the exclusive containers according to the third embodiment; and

FIG. 19 is a schematic diagram illustrating an example of the hardware configuration.

### DESCRIPTION OF EMBODIMENTS

Preferred embodiments of the present invention will be explained with reference to accompanying drawings. Furthermore, the present invention is not limited to these embodiments. Furthermore, the embodiments can be appropriately used in combination as long as processes do not conflict with each other.

### [a] First Embodiment

Overall Configuration

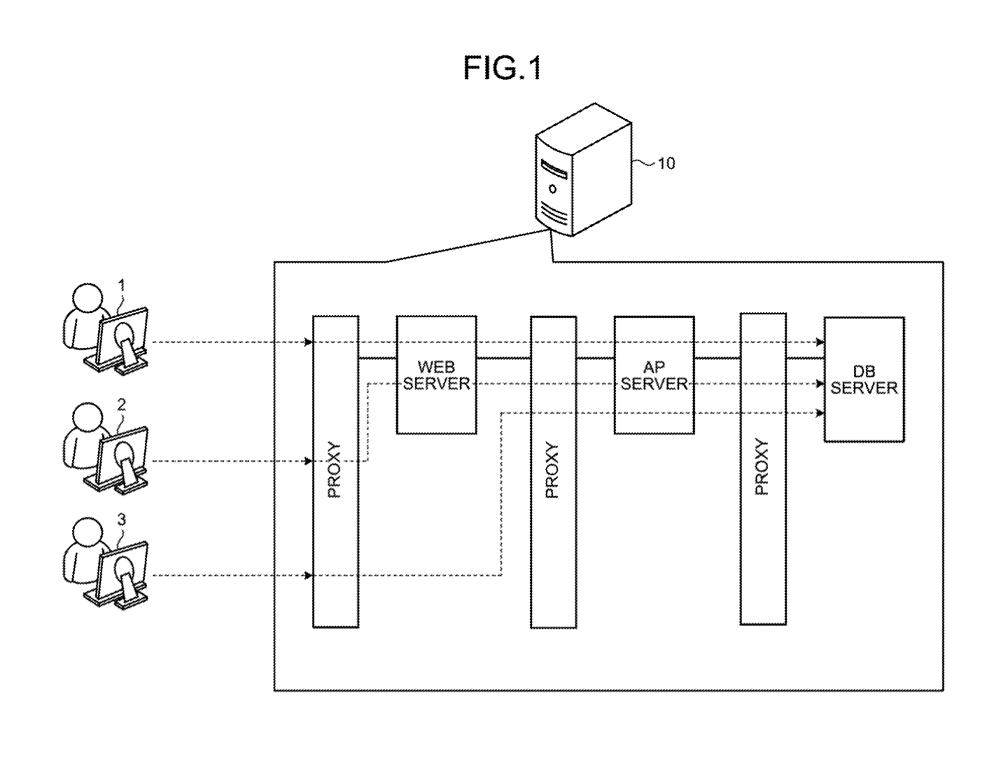

FIG. 1 is a schematic diagram illustrating a system according to a first embodiment. As illustrated in FIG. 1, this system is a system that includes a plurality of user terminals 1 to 3 and a test control device 10 and that provides a test environment to each of the user terminals. This system provides, to each of the user terminals, a test environment of an operation system that provides a service by using an ICT system constituted by a plurality of components, such as a Web server, an AP, a DB, and the like. In the embodiment, a description will be given by using, as an example, a three-tier system constituted by the Web, the AP, and the DB servers in this order.

Each of the user terminals is a terminal of a user who revises the ICT system and is a terminal, such as a server, a notebook computer, a mobile terminal, or the like. The users revise, by using their respective user terminals, the components handled by themselves and detect abnormality after the revision by using a test case.

The test case mentioned here is performed such that, in order to check whether the content, an application, a database schema, or the like is normally operated, a certain operation and an expected value with respect to the certain operation are described; the result of the actual operation is compared with the expected value; and, if both are the same, it is determined that the test has been successful. Some test case, such as the static content in a Web including, for example, an image or the like, is not changed due to a normal access and some test case, such as data in a DB including, for example, the number of accesses or the like, is changed even if the access is just the test access. Alternatively, in order to perform a test for a log in a system, there may sometimes be a need for preparations for the test in which information on test users is previously registered in a DB.

The test control device 10 is a server device that provides a test environment to a user who revises the system that includes a plurality of components. Specifically, the test control device 10 provides a test environment to each of the user terminals by using a physical server, a virtual machine, a container, or the like. Here, the test environment may also be configured in the test control device 10 or may also be configured in another physical server.

With this configuration, the test control device 10 stores therein, for each user who revises the system that includes therein a plurality of components, a use configuration table in which the type of components used in revision is associated with the connection relation between the components that are used in the revision. Then, if the test control device 10 receives a request from a user terminal, the test control device 10 specifies, on the basis of the use configuration table associated with the user of the subject user terminal, the type of the component that serves as the transfer destination of the request. Then, if the server device associated with the specified type is running, the test control device 10 transfers a request to the server device and, if the server device has not been started up, the test control device 10 starts up the subject server device and transfers the request to the started up server device.

For example, the test control device 10 starts up the proxy. The proxy to be started up here may also be a container. Then, the test control device 10 receives the request sent from a user by using the proxy. Then, if the container at the transfer destination is not present, the test control device 10 newly starts up the container, transfers the request to the started up container, and transfer, if the target container has already been present, the test control device 10 sends a request to the subject container.

Namely, as illustrated in FIG. 1, the test control device 10 creates, with respect to the user terminal 1 that has sent the request first, each of the containers, i.e., a Web server, an AP server, and a DB server, that are used by the user terminal 1. Then, regarding the user terminal 2 that has sent the request second time, because each of the containers of the Web server, the AP server, and the DB server that are used by the user terminal 2 has already been started up, the test control device 10 transfers the request to each of the container that is created at the time of request received from the user terminal 1. Finally, regarding the user terminal 3 that has sent the request third time, because the containers of the AP server and the DB server used by the user terminal 3 have already been started up, the test control device 10 transfers the request to the container of the AP server that has created at the time of request received from the user terminal 1.

In this way, the test control device 10 can share the containers that were started up with respect to a certain user terminal and allow the other user terminals to also use the containers. Consequently, the test control device 10 can provide a convenient test environment in which the number of resources to be used is reduced. Furthermore, FIG. 1 illustrates an example in which the proxy is started up with respect to each of the container; however, the embodiment is not limited to this and the requests can be distributed by a single proxy.

Functional Configuration

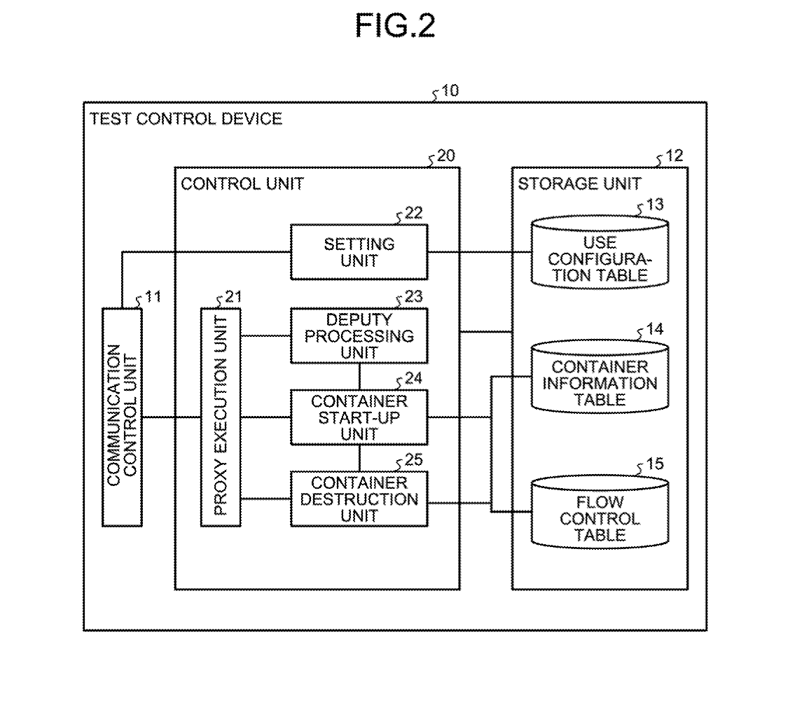

FIG. 2 is a functional block diagram illustrating the functional configuration of the test control device 10 according to the first embodiment. In the embodiment, a description will be given of an example in which a test environment is created in another casing or the like that is other than the test control device 10. As illustrated in FIG. 2, the test control device 10 includes a communication control unit 11, a storage unit 12, and a control unit 20.

The communication control unit 11 is a processing unit that controls communication with the other device and is, for example, a network interface card. For example, the communication control unit 11 receives a request for performing a test case from each of the user terminals and sends the test result to each of the user terminals.

The storage unit 12 is a storage device that stores therein programs or various kinds of data executed by the control unit 20 and is, for example, a memory, a hard disk, or the like. The storage unit 12 stores therein a use configuration table 13, a container information table 14, and a flow control table 15. Furthermore, here, a description will be given of using a table as an example; however, the data format is not limited to this and another format, such as a text format, DB, or the like, may also be used.

The use configuration table 13 stores therein, in an associated manner for each user who revises the system that includes a plurality of components, the type of the components that are used by revision and the connection relation between the components.

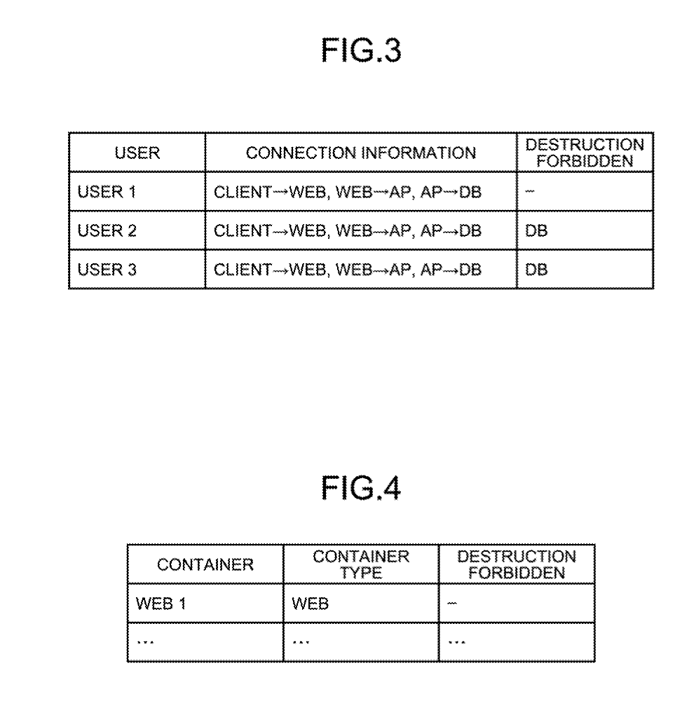

FIG. 3 is a schematic diagram illustrating an example of information stored in the use configuration table 13. As illustrated in FIG. 3, the use configuration table 13 stores therein, in an associated manner, the user, the connection information, and the destruction forbidden. The “user” stored here is the identifier that identifies a user who revises the system, i.e., identifies a terminal used by the user. The “connection information” is information indicating the connection relation between the container that is used by the user terminal and the type of container to be used. The “destruction forbidden” is information that is used to set the status indicating whether, if a specific condition is satisfied, automatic destruction that automatically destroys the container is invalid.

The example illustrated in FIG. 3 indicates that a “user 1” uses the containers of the Web server, the AP server, and the DB server and indicates that the connection relation between the containers is from the client to the Web server, from the Web server to the AP server, and from the AP server to the DB server. Furthermore, in any of the containers, the automatic destruction is valid. Furthermore, regarding a “user 2”, the type (container type) of the container to be used and the connection relation are the same as those of the user 1; however, regarding the “DB server”, the automatic destruction is set to be invalid.

The container information table 14 stores therein the information related to the container that has already started up. FIG. 4 is a schematic diagram illustrating an example of information stored in the container information table 14. As illustrated in FIG. 4, the container information table 14 stores therein, in an associated manner, the container, the container type, and the destruction forbidden.

The “container” stored here indicates an identifier that identifies the container that has already been started up; the “container type” indicates the container that has already been started up; and the “destruction forbidden” indicates the setting of the automatic destruction. The example illustrated in FIG. 4 indicates that the container “Web 1” corresponding to the “Web server” is started up in a state in which the automatic destruction has been approved.

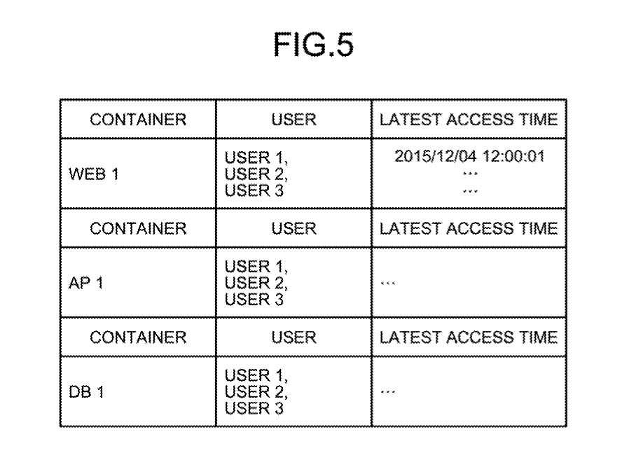

The flow control table 15 stores therein, for each container that is started up in the test environment, information related to the communication that has occurred in the test environment. FIG. 5 is a schematic diagram illustrating an example of information stored in a flow control table. As illustrated in FIG. 5, the flow control table 15 stores therein, in an associated manner, the container, the user, and the latest access time.

The “container” stored here is information indicating the container type targeted for an access; the “user” is information indicating the accessed user; and the “latest access time” is the latest date and time at which the user accessed the container. The example illustrated in FIG. 5 indicates that an access is performed by the “user 1” with respect to the container “Web 1” at “12:00:01 on 2015/12/4”.

The control unit 20 is a processing unit that manages the overall process performed by the test control device 10 and is, for example, a processor or the like. The control unit 20 includes a proxy execution unit 21, a setting unit 22, a deputy processing unit 23, a container start-up unit 24, and a container destruction unit 25. Furthermore, the proxy execution unit 21, the setting unit 22, the deputy processing unit 23, the container start-up unit 24, and the container destruction unit 25 are an example of an electronic circuit, such as a processor or an example of the processes performed by the processor.

The proxy execution unit 21 is a processing unit that receives a request and that sends, as a response, the processing result. Specifically, if a process is started, the proxy execution unit 21 refers to the use configuration table 13, acquires the container type, and starts up, for each acquired container type, the proxy container. In this way, the proxy execution unit 21 sends a proxy response as the test environment to each of the user terminals.

For example, when the proxy execution unit 21 receives a request from the user terminal, the proxy execution unit 21 outputs the request to the deputy processing unit 23. Furthermore, if the proxy execution unit 21 receives a response to the request from the deputy processing unit 23 or the like, the proxy execution unit 21 sends the response to the user terminal that is the request source.

Furthermore, if the proxy execution unit 21 receives a request from each of the containers, the proxy execution unit 21 outputs the request to the deputy processing unit 23. In the following, a description will be given of the user 1 illustrated in FIG. 3. The proxy execution unit 21 receives a request from the user terminal 1; outputs the request to the deputy processing unit 23; then, receives the request from the container that is the Web server, and outputs the request to the deputy processing unit 23. Furthermore, the proxy execution unit 21 receives the request from the container that is the AP server, outputs the request to the deputy processing unit 23; then, receives the request from the container that is the DB server; and outputs the request to the deputy processing unit 23. Thereafter, the proxy execution unit 21 sends, to the user terminal 1 as a response, the result received from the container that is the DB server.

Here, in the system that is a multi tier system, such as Web-AP-DB or the like, regarding the identification of an access to the second tier and the subsequent tiers performed by a user, various kinds of known methods can be used. For example, the identification can be performed such that, in each of the components, identification information on a user, such as a transmission source address, is inserted into an area in which the logical meaning of a message, such as a comment, an option header, or the like, is changed and is then transmitted. Furthermore, it is also previously specify the information that associates an access from a user with an access to the second tier and the subsequent tiers and then associate communication by using the specified information.

The setting unit 22 is a processing unit that receives, for each user who revises the system that includes a plurality of components, the setting of associating the type of component that is used in the revision with the connection relation between the components that are used in the revision. Specifically, the setting unit 22 receives the registration of the use configuration table 13 from each of the user terminals.

The deputy processing unit 23 is a processing unit that distributes the requests sent from the user terminals to the subject containers. Specifically, if the deputy processing unit 23 receives a request from the user terminal or each of the containers, the deputy processing unit 23 refers to the use configuration table 13 and specifies the component that serves as the next transfer destination. Then, if the deputy processing unit 23 specifies the component that serves as the next transfer destination, the deputy processing unit 23 refers to the container information table 14 and determines whether the container associated with the subject component is running.

Then, if the subject container is running, the deputy processing unit 23 transfers the request to the subject container and updates the flow control table 15. In contrast, if the subject container has not been started up, the deputy processing unit 23 sends an instruction to start up the container to the container start-up unit 24. Then, if the subject container is started up, the deputy processing unit 23 transfers the request to the subject container and updates the flow control table 15.

For example, when the deputy processing unit 23 receives, from the user terminal 1, the request to which the ID of the user 1 of the user terminal 1, the address information, and the like are attached, the deputy processing unit 23 refers to the use configuration table 13 and specifies that the transfer destination of the request is the Web. Then, the deputy processing unit 23 refers to the flow control table 15 and specifies the entry targeted for the user 1. Here, if the entry is present in the flow control table 15, the deputy processing unit 23 acquires the container “Web 1” and transfers the request to the container “Web 1”. At this time, the deputy processing unit 23 acquires the current time and updates the latest access time of the subject entry in the flow control table 15.

In contrast, if the entry of the “user 1” is not present in the flow control table 15, the deputy processing unit 23 refers to the container information table 14 and determines whether the entry of the container type “Web” is present. Then, if the entry of the container type “Web” is present in the container information table 14, the deputy processing unit 23 acquires the container “Web 1” that is associated with the container type “Web”. Subsequently, the deputy processing unit 23 searches the flow control table 15 for the entry associated with the container “Web 1”; adds, if the entry is present, a postscript of the “user 1” to the “user”; and requests, if the entry is not present, the container start-up unit 24 to newly create the entry of “container=Web 1, user=user 1, and destruction forbidden=−”. Then, the deputy processing unit 23 transfers the request to the Web container “Web 1”, acquires the current time, and updates the latest access time of the subject entry stored in the flow control table 15.

Furthermore, if an entry of the Web is not present in the container information table 14, the deputy processing unit 23 sends, to the container start-up unit 24, an instruction to create a container of a Web. Then, if the container “Web 1” of the Web is started up, the deputy processing unit 23 performs the same process as that described above, transfers the request to the Web container “Web 1”, acquires the current time, and updates the latest access time of the subject entry in the flow control table 15.

Furthermore, here, the request for the Web container has been described; however, the same method can also be used for the process performed on the AP or the DB.

The container start-up unit 24 is a processing unit that starts up the container of the subject component. Specifically, the container start-up unit 24 starts up the container indicated by the deputy processing unit 23 and creates, in the container information table 14, the entry associated with the started up container.

For example, if the container start-up unit 24 receives an instruction to create a container of a Web from the deputy processing unit 23, the container start-up unit 24 refers to the container information table 14 and acquires the number of Web containers that have been started up. Here, if the Web container has not been started up, because the Web container is the first target for the startup, the container start-up unit 24 sets the Web container targeted for the startup to “Web 1”. Then, the container start-up unit 24 starts up the container of the “Web 1” for the test environment and creates, in the container information table 14, an entry of “container=Web 1 and container type=Web”. Furthermore, the container start-up unit 24 specifies, from the use configuration table 13, the entry associated with the “user 1” that is the request transmission source and acquires “destruction forbidden=−”. Then, the container start-up unit 24 adds a postscript of “destruction forbidden=−” to the entry of “container=Web 1 and container type=Web” stored in the container information table 14. Thereafter, the container start-up unit 24 notifies, as a response, the deputy processing unit 23 that the startup of the container has been started. Furthermore, each of the tables can also be created by the deputy processing unit 23.

The container destruction unit 25 is a processing unit that discards the container that satisfies a predetermined condition. Specifically, the container destruction unit 25 searches, for each entry in the container information table 14, whether the entry of the target container is present in the flow control table 15; determines, if the entry is not present, that the target container is not needed; and deletes the container. After the deletion, the container destruction unit 25 also deletes the subject entry in the container information table 14.

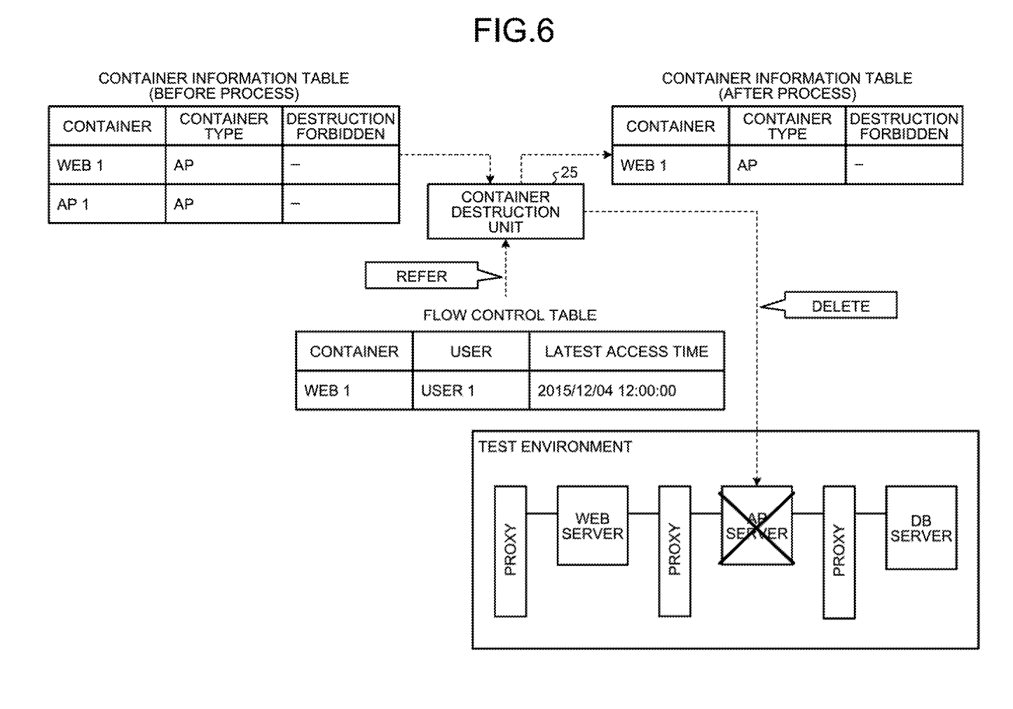

FIG. 6 is a schematic diagram illustrating deletion of a container. As illustrated in FIG. 6, in the container information table 14, the entry of “Web 1” and the entry of “AP 1” are registered. In this state, if the container destruction unit 25 refers to the flow control table 15, the container destruction unit 25 determines that the entry of “Web 1” is present in the flow control table 15 but the entry of “AP 1” is not present in the flow control table 15. Then, the container destruction unit 25 deletes the container of the “AP server” associated with “AP 1” that is in the test environment from the test environment. Subsequently, the container destruction unit 25 deletes the entry of “AP 1” from the flow control table 15. In this way, the container destruction unit 25 releases the resources, such as the processor, the memory, and the like, that were being used by the container of the “AP server”.

The deletion process described above can be periodically performed; however, the trigger of the deletion is not limited to this. For example, the container destruction unit 25 determines, for each entry stored in the flow control table 15, whether the latest access time is the time T (for example, one hour) before the current time. Then, the container destruction unit 25 deletes, from the flow control table 15, the entry in which the latest access time is the time T before the current time and also deletes the subject container from the test environment. Furthermore, the container destruction unit 25 can also delete the subject container after a user explicitly notifies, via the user interface, of the end of the use of the system.

Flow of the Process

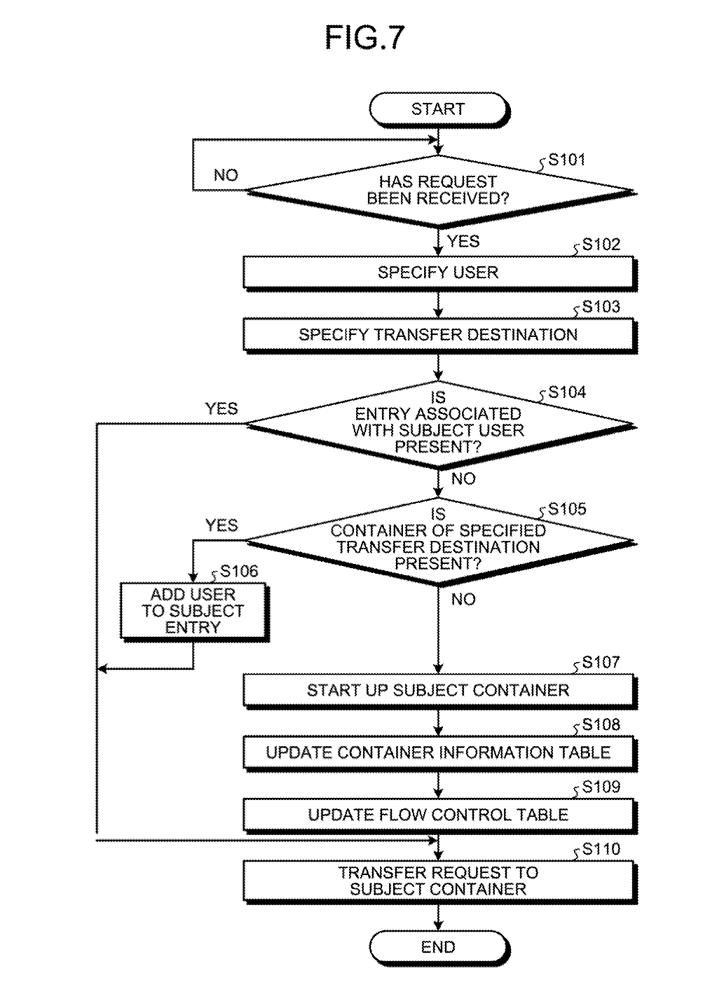

FIG. 7 is a flowchart illustrating the flow of a container start up process and a request transfer process according to the first embodiment. As illustrated in FIG. 7, if a request is received by the proxy execution unit 21 (Yes at Step S101), the deputy processing unit 23 specifies a user on the basis of the request (Step S102).

Subsequently, the deputy processing unit 23 specifies the entry associated with the specified user from the use configuration table 13 and specifies the transfer destination (Step S103). Then, the deputy processing unit 23 refers to the flow control table 15, searches for the entry associated with the specified user (Step S104), and transfers, if the entry is present (Yes at Step S104), the entry to the subject container (Step S110).

In contrast, if the entry of the subject user is not present in the flow control table 15 (No at Step S104), the deputy processing unit 23 searches the flow control table 15 for the entry that is associated with the container of the specified transfer destination (Step S105).

Then, if the entry of the subject container is present in the flow control table 15 (Yes at Step S105), the deputy processing unit 23 adds the user (user ID) to the entry of the subject container (Step S106) and transfers the request to the subject container (Step S110).

In contrast, if the deputy processing unit 23 determines that the entry of the subject container is not present in the flow control table 15 (No at Step S105), the container start-up unit 24 starts up the subject container (Step S107). Subsequently, the container start-up unit 24 adds the entry of the subject container, updates the container information table 14 (Step S108), adds the entry of the subject container and the user, and updates the flow control table 15 (Step S109). Furthermore, each of the tables can also be updated by the deputy processing unit 23. Then, the deputy processing unit 23 transfers the received request to the started up container (Step S110).

Specific Example of Revision

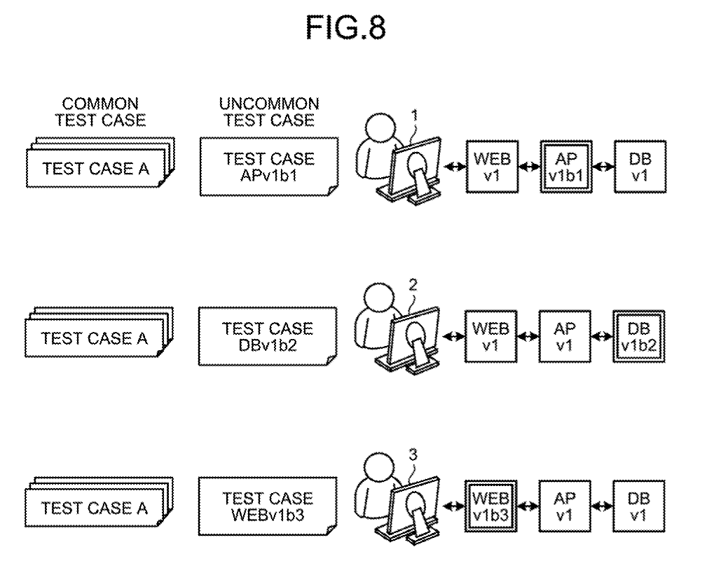

FIG. 8 is a schematic diagram illustrating revision of a component according to the first embodiment. The diagram illustrated in FIG. 8 indicates an example in which the users 1 to 3 are the developer of the same system but the components handled by the users are different. Furthermore, the symbol v illustrated in FIG. 8 indicates a version and the symbol b indicates a branch. Furthermore, before the revision, each of the users tests the components by using the common test case A.

In FIG. 8, the user 1 revises the AP server (AP v1) of the version 1, the user 2 revises the DB server (DBv1) of the version 1, and the user 3 revises the Web server (Web v1) of the version 1.

Thus, because the user 1 revises the component (AP v1) to the component (AP v1b1), the user 1 modifies the test case A to the test case AP v1b1 and tests the revised component (AP v1b1).

Similarly, because the user 2 revises the component (DB v1) to the component (DB v1b2), the user 2 modifies the test case A to the test case DB v1b2 and tests the revised component (DB v1b2).

Similarly, because the user 3 revises the component (Web v1) to the component (Web v1b3), the user 3 modifies the test case A to the test case Web v1b3 and tests the revised component (Web v1b3).

In this way, when the service in the Web is frequently revised, a change at the time of a certain revision is a small portion of the system, the component of the most part of the system is not changed, and a change in the test case is only a small portion. Consequently, it is possible to share the component other than the component to be revised.

Effect

In a recent Web service, in order to reduce the relationship between the components and reduce the degree of influence, loose coupling is performed and the structure of one component to one container is usually set. Furthermore, the system is constituted by many components and is accordingly constituted by many containers. Thus, at a certain revision, most containers are not revised. Furthermore, each of the members in the team who perform the development handles different parts; however, the state is consequently the same because most components (containers) of test cases are not revised.

Accordingly, as described in the embodiment, the resources can be reduced by sharing, using the containers, the components other than the component targeted for the revision. For example, if the system constituted by the Web server, the AP server, and the DB server is revised by three users, conventionally, a test environment is created by using nine containers; however, by using the embodiment described above, the test environment can be created by three containers. Accordingly, it is possible to implement a reduction in the resources. Furthermore, because each of the users can perform the revision and the test in parallel, it is also possible to suppress a decrease in convenience. Namely, it is possible to provide a highly convenient test environment in which the number of resources to be used is reduced.

### [b] Second Embodiment

In the first embodiment, a description has been given of the example of sharing each of the containers by each of the users; however, depending on the content of revision or the like, a case occurs in which a test is performed by exclusively using the container. Thus, in a second embodiment, a description will be given of an example of creating a test environment in which some container is exclusively used. Furthermore, it is assumed that the system configuration, the component configuration, and the like are the same as those described in the first embodiment.

Functional Configuration

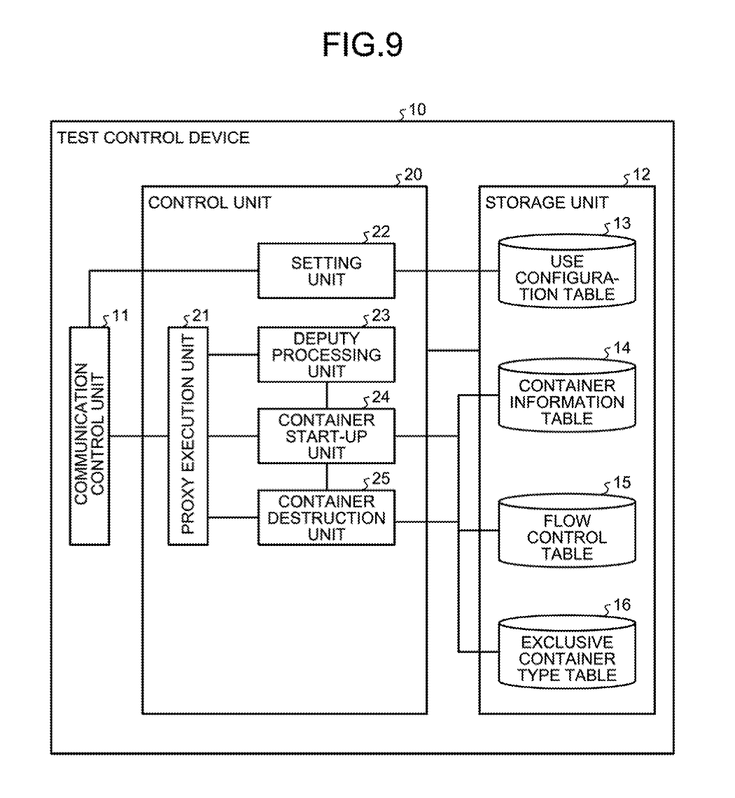

FIG. 9 is a functional block diagram illustrating the functional configuration of the test control device 10 according to a second embodiment. The test control device 10 illustrated in FIG. 9 includes, similarly to that illustrated in FIG. 2 in the first embodiment, the communication control unit 11, the storage unit 12, and the control unit 20. However, the test control device 10 is different from that described in the first embodiment in that the test control device 10 includes an exclusive container type table 16. In the second embodiment, portions different from the first embodiment will be described.

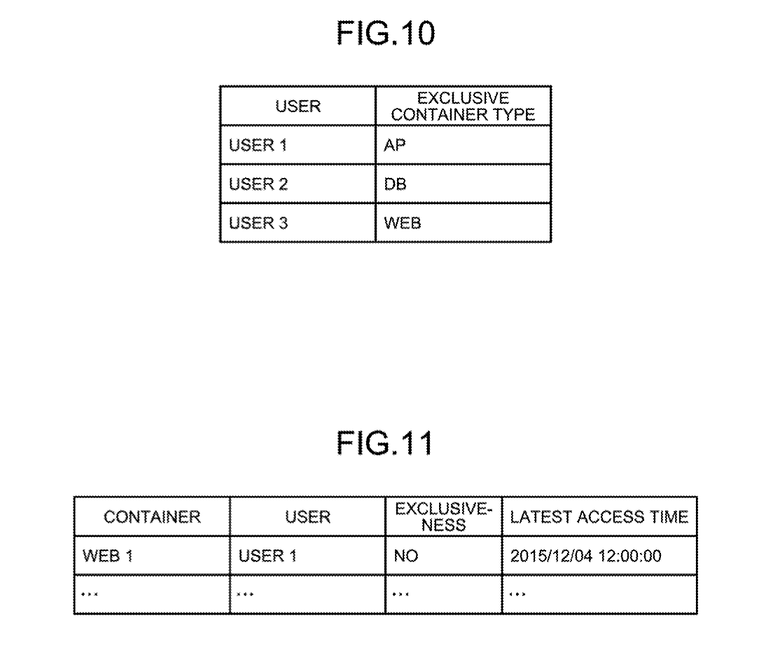

The exclusive container type table 16 stores therein the type of the container exclusively used by each of the users. The information stored here can be set by the users. FIG. 10 is a schematic diagram illustrating an example of information stored in the exclusive container type table 16 according to the second embodiment.

As illustrated in FIG. 10, the exclusive container type table 16 stores therein, in an associated manner, the user and the exclusive container type. The “user” is an identifier or the like that identifies each of the users and the “exclusive container type” is the type of the containers exclusively used by the users. The example illustrated in FIG. 10 indicates that the user 1 exclusively uses the container of the AP server.

Furthermore, because the exclusive container is created, the information that is different from that described in the first embodiment is also added to the flow control table 15. FIG. 11 is a schematic diagram illustrating an example of information stored in the flow control table 15 according to the second embodiment. As illustrated in FIG. 11, in the flow control table 15 according to the second embodiment, in addition to the items of the container, the user, and the latest access time described in the first embodiment, the item of the column of “exclusiveness” indicating whether the container is exclusively used is added. The example illustrated in FIG. 11 illustrates that the user 1 accessed the container of the Web 1 that is exclusively used by the user 1 at “12:00:00 on 2015/12/04”.

Furthermore, in the first embodiment, if the subject container is running, the deputy processing unit 23 transfers the request and instructs, if the subject container has not been started up, the container start-up unit 24 to start up the container; however, in addition to this, the deputy processing unit 23 determines whether the subject container is an exclusive container.

Specifically, if the deputy processing unit 23 receives a request from the user terminal 1, the deputy processing unit 23 refers to the use configuration table 13 and specifies that the container that serves as the subsequent transfer destination is the “Web”. Subsequently, the deputy processing unit 23 refers to the flow control table 15 and specifies the entry associated with the user 1. Here, if the subject entry is present in the flow control table 15, the deputy processing unit 23 acquires the “Web” indicated by the subject container information and transfers the request to the subject container that is the “Web”. At this time, the deputy processing unit 23 acquires the current time and updates the latest access time of the subject entry stored in the flow control table 15.

In contrast, if the entry of the “user 1” is not present in the flow control table 15, the deputy processing unit 23 refers to the container information table 14 and determines whether the entry of the container type of “Web” is present. Then, if the entry of the container type of “Web” is present in the container information table 14, the deputy processing unit 23 acquires the container “Web 1” associated with the container type of “Web”. Subsequently, the deputy processing unit 23 searches the flow control table 15 for the entry that is associated with the container “Web 1”; adds, if the entry of “exclusiveness=no” is present, the “user 1” as a postscript; and transfers the entry.

Here, if the entry of the container “Web 1” associated with “exclusiveness=yes” is present in the flow control table 15, the deputy processing unit 23 instructs the container start-up unit 24 to create a container “Web 2” that is a new container. At this time, the container start-up unit 24 refers to the exclusive container type table 16 associated with the user 1, finds that the exclusive container type is “AP”, and thus creates the container “Web 2” in which “exclusiveness=no” is set. Then, the deputy processing unit 23 transfers the request to the newly created container of “Web 2” and updates the latest access time of the subject entry stored in the flow control table 15.

Furthermore, if the subject entry is not present in the flow control table 15, the deputy processing unit 23 requests the container start-up unit 24 to newly create the entry of “container=Web 1, user=user 1, and destruction forbidden=−”. At this time, the container start-up unit 24 refers to the exclusive container type table 16 associated with the user 1; creates, because the exclusive container type is “AP”, the container of “Web 2” in which “exclusiveness=no” is set; and creates the requested entry. Then, the deputy processing unit 23 transfers the request to the Web container “Web 1” and updates the latest access time of the subject entry stored in the flow control table 15.

Flow of the Process

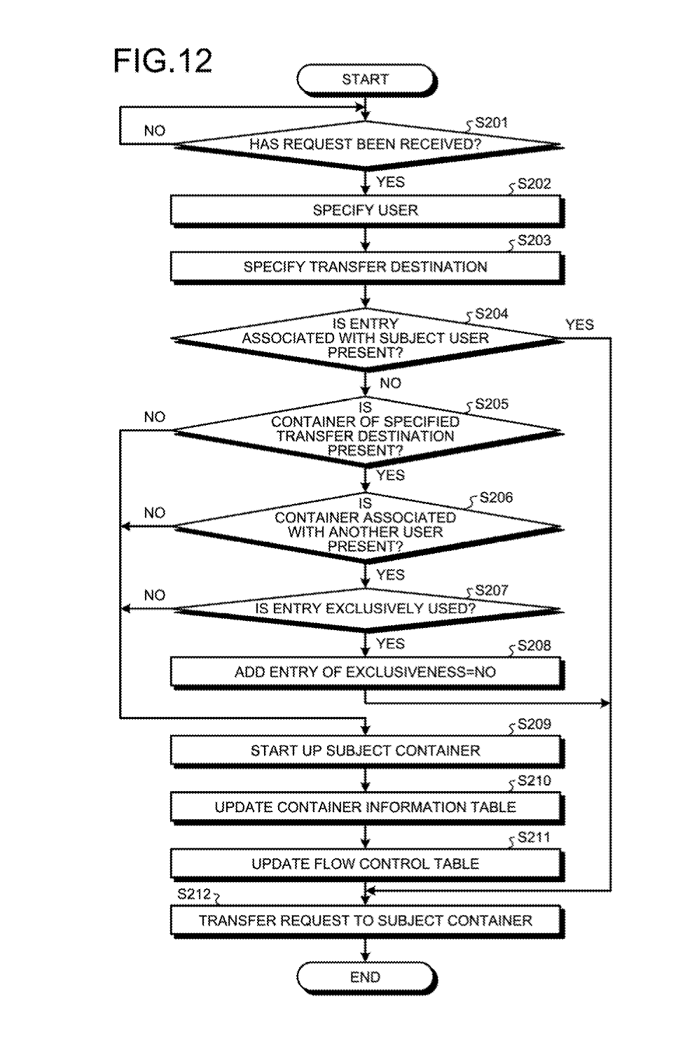

FIG. 12 is a flowchart illustrating the flow of a container startup process and a request transfer process according to the second embodiment. As illustrated in FIG. 12, if a request is received by the proxy execution unit 21 (Yes at Step S201), the deputy processing unit 23 specifies the user from the request (Step S202).

Subsequently, the deputy processing unit 23 specifies the entry associated with the specified user from the use configuration table 13 and specifies the transfer destination (Step S203). Then, the deputy processing unit 23 refers to the flow control table 15; searches for the entry associated with the specified user (Step S204); and transfers, if the entry is present (Yes at Step S204), the request to the subject container (Step S212).

In contrast, if the entry of the subject user is not present in the flow control table 15 (No at Step S204), the deputy processing unit 23 searches the flow control table 15 for the entry associated with the container of the specified transfer destination (Step S205).

Then, if the entry of the subject container is present in the flow control table 15 (Yes at Step S205), if the entry of the subject container is not the exclusive container type of the subject user and is the container of the other user (Yes at Step S206), and if the subject container is not the exclusive container type of the other user (Yes at Step S207), the deputy processing unit 23 adds “exclusiveness=no and user=user 1” to the subject entry (Step S208). Then, the deputy processing unit 23 transfers the request to the subject container (Step S212).

In contrast, if the entry of the subject container is not present in the flow control table 15 (No at Step S205), or, if the entry of the subject container is the exclusive container type of the subject user or is not the container of the other user (No at Step S206), or, if the entry of the subject container is the exclusive container type of the other user (No at Step S207), the process at Step S209 and the subsequent processes are performed.

Namely, the container start-up unit 24 starts up the subject container (Step S209). Subsequently, the container start-up unit 24 adds the entry of the subject container; updates the container information table 14 (Step S210); adds the entry of the subject container and the user; and updates the flow control table 15 (Step S211). Furthermore, the update of each of the tables can be performed by the deputy processing unit 23. Then, the deputy processing unit 23 transfers the received request to the started up container (Step S212).

### Specific Example

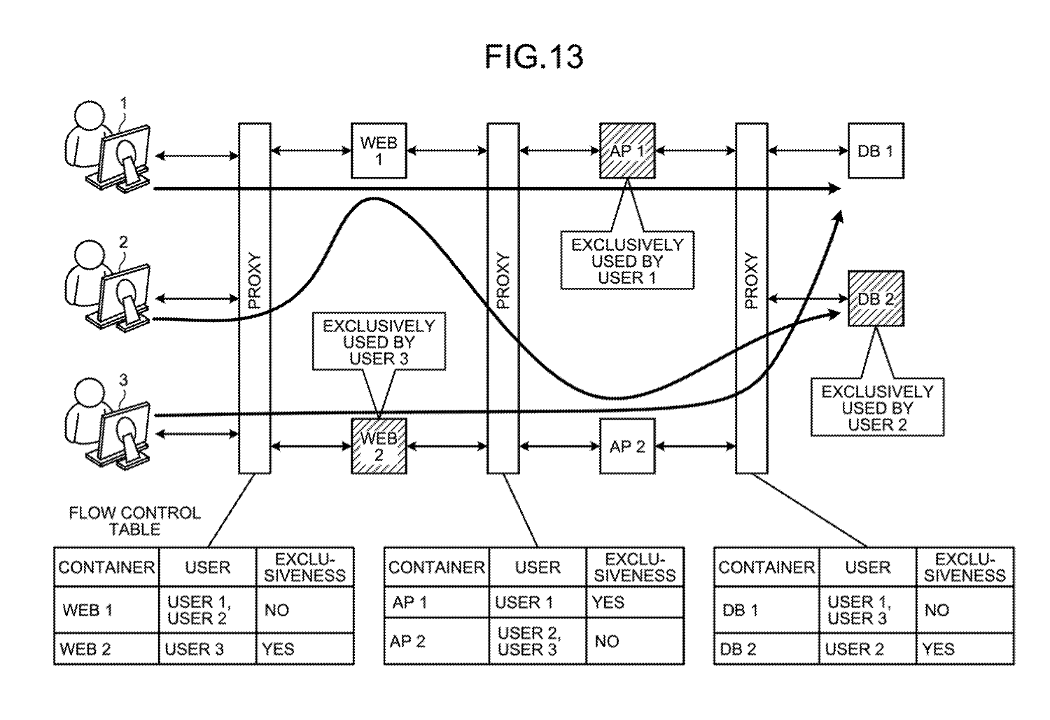

In the following, a description will be given of an example in which the users 1 to 3 use the components of the Web, the AP, and the DB, respectively. Here, a description will be given of an example in which requests are sequentially issued starting from the user 1, the user 1 exclusively uses the AP, the user 2 exclusively uses the DB, and the user 3 exclusively uses the Web. FIG. 13 is a schematic diagram illustrating a test environment using the exclusive containers according to the second embodiment.

First, if the test control device 10 receives a request from the user 1, the test control device 10 creates, in accordance with the use configuration table 13, the container “Web 1” of “exclusiveness=no” and transfers the request. Then, the test control device 10 creates, as the transfer destination of the request from the container “Web 1”, the container “AP 1” of “exclusiveness=yes” and transfers the request. Thereafter, the test control device 10 creates, as the transfer destination of the request from the exclusive container “AP 1”, the container “DB1” of “exclusiveness=no” and transfers the request.

At this point, in the flow control table 15, “user=user 1 and exclusiveness=no” is stored by being associated with “container=Web 1”; “user=user 1 and exclusiveness=yes” is stored by being associated with “container=AP 1”; and “user=user 1 and exclusiveness=no” is stored by being associated with “container=DB1”. Furthermore, a description of the latest access time will be omitted.

Then, if the test control device 10 receives the request from the user 2, because the container “Web 1” of “exclusiveness=no” serving as the “Web” that is the transfer destination has already been started up, the test control device 10 transfers the request to this container “Web 1”. Subsequently, if the test control device 10 receives the request from the container “Web 1”, because the container “AP 1” has already been started up as the “AP” that is the transfer destination but the container “AP 1” is in the exclusive state, the test control device 10 newly creates a container “AP 2” of “exclusiveness=no” and transfers the request to the container “AP 2”. Then, if the test control device 10 receives the request from the container “AP 2”, the test control device 10 detects that the container “DB1” of “exclusiveness=no” serving as the transfer destination has already been started up but the DB is set in the exclusive container type of the user 2. Then, the test control device 10 creates the container “DB2” of the new DB server in which “exclusiveness=yes” is set and then transfers the request to this container “DB2”.

At this point, in the flow control table 15, “user=user 1, user 2, and exclusiveness=no” are stored by being associated with “container=Web 1”. Furthermore, in the flow control table 15, “user=user 1 and exclusiveness=yes” are stored by being associated with “container=AP 1” and “user=user 2 and exclusiveness=no” are stored by being associated with “container=AP 2”. Furthermore, in the flow control table 15, “user=user 1 and exclusiveness=no” are stored by being associated with “container=DB1” and “user=user 2 and exclusiveness=yes” are stored by being associated with “container=DB2”.

Then, if the test control device 10 receives the request from the user 3, the test control device 10 detects that the container “Web 1” has already been started up as the “Web” that is the transfer destination but the Web is set to the exclusive container type of the user 3. Then, the test control device 10 creates the container “Web 2” of a new Web server in which “exclusiveness=yes” is set and then transfers the request to the container “Web 2”. Subsequently, if the test control device 10 receives the request from the container “Web 2”, because container “AP 2” of “exclusiveness=no” has already been started up as the “AP” that is the transfer destination, the test control device 10 transfers the request to the container “AP 2”. Then, if the test control device 10 receives the request from the container “AP 2”, because the container “DB1” of “exclusiveness=no” has already been started up as the transfer destination, the test control device 10 transfers the request to the container “DB1”.

At this point, in the flow control table 15, “user=user 1, user 2, and exclusiveness=no” are stored by being associated with “container=Web 1” and “user=user 3 and exclusiveness=yes” are stored by being associated with “container=Web 2”. Furthermore, in the flow control table 15, “user=user 1 and exclusiveness=yes” are stored by being associated with “container=AP 1” and “user=user 2, user 3, and exclusiveness=no” are associated with “container=AP 2”. Furthermore, in the flow control table 15, “user=user 1, user 3, and exclusiveness=no” are stored by being associated with “container=DB1” and “user=user 2 and exclusiveness=yes” are stored by being associated with “container=DB2”.

Effect

As described above, the test control device 10 can create a system environment in which the exclusive containers and shared containers are present in a mixed manner and can provide a test environment suitable for each of the users; therefore, it is possible to improve convenience of the users while reducing the resources.

### [c] Third Embodiment

In the first and the second embodiments, the description has been given with the assumption that the container type that is to be exclusively used is known in advance; however, depending on the circumstances, it may sometimes be difficult to specify the scene of the exclusiveness. For example, when a test set is performed, there may be a case in which a certain test case exclusively needs only the Web tier and the other test case exclusively needs only the DB tier. In this case, it is difficult for a user previously designates the exclusiveness without omission.

Thus, in a third embodiment, a description will be given of an example in which, when a test case is performed, exclusive information is dynamically determined. This estimates, from the execution result of a certain test case and from information on a path in which an operation is being performed, whether the exclusiveness is needed for a certain container type that is present in order to perform the test case.

The test case mentioned here is performed such that, as described above, in order to check whether the content, an application, a database schema, and the like are normally operated, a certain operation and an expected value thereof are described and the result of the actual operation is compared with the expected value. Here, it is assumed that preprocessing (a preparation needed for the test), a test operation, and post-processing (returns the system to the original) are performed in each of the test cases. Thus, even if any of the tests are performed in any order, no problem occurs unless the above described operations are simultaneously performed. Furthermore, the test set is the set of the test cases. Furthermore, the unique ID is attached to each test case. Here, T1, T2, . . . , and Tn represents each of the test cases. Furthermore, even if the test cases have the same name, a new ID is attached every time a change occurs.

Estimation of a Use Container

First, the test control device 10 acquires the operation state when a test case is performed by a user. Specifically, regarding all of the test cases, the test control device 10 registers, as the exclusiveness, all of the containers in the exclusive container type table 16 that is used in the second embodiment. The test control device 10 performs the test cases T1, T2, T3, . . . , and Tn.

Here, even if one of the test cases has failed, because corrections of the test case and the target code are needed, the test control device 10 notifies the user via the user interface of this state and ends the process. Furthermore, if all of the test cases have been successful, the test control device 10 acquires the path for each test case from the log in the proxy execution unit 21. Furthermore, the proxy execution unit 21 records the time, the user, the container type, and the test case in a use log.

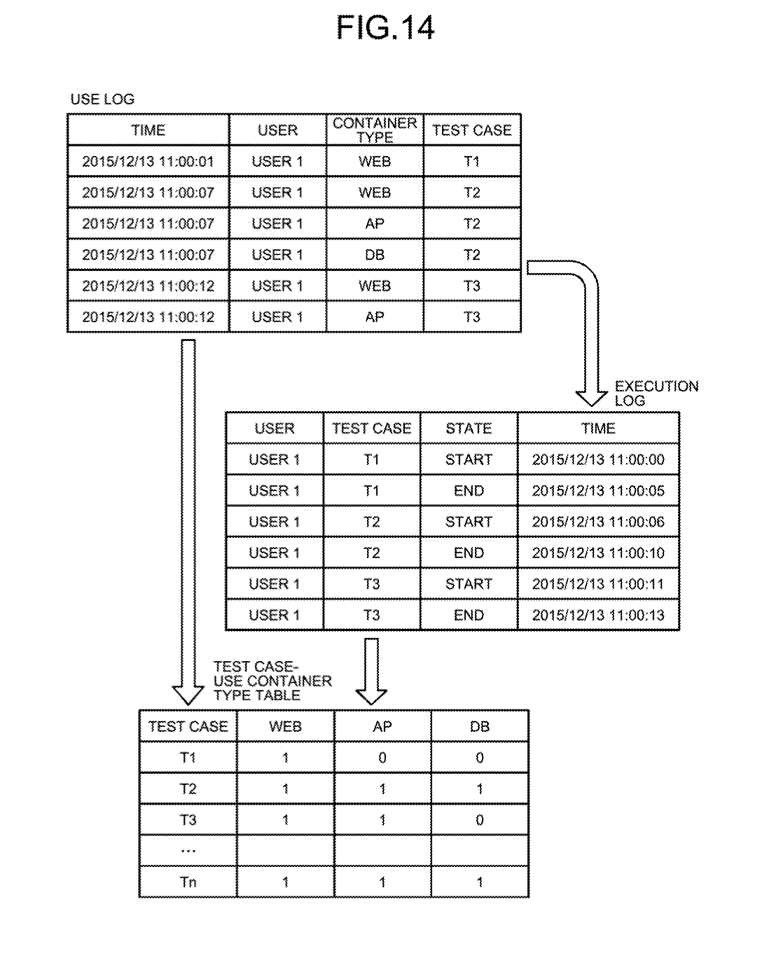

FIG. 14 is a schematic diagram illustrating estimation of use containers according to the third embodiment. As illustrated in FIG. 14, when the test control device 10 performs the test case, the test control device 10 acquires the use log that includes therein the time, the user, the container type, and the test case. Furthermore, the test control device 10 acquires, every time the test control device 10 performs the test case, an execution log that includes therein the user, the test case, the state (start or end), and the time from the proxy execution unit 21.

Then, the test control device 10 checks the use log against the execution log and acquires the use container type (test case-use container type table) that was used when a certain test case was performed. Namely, in the use log that is related to the user in the execution log and that is in the range between the start of the test case and the end time, the test control device 10 acquires the container type of the test case of the matched user. For example, regarding the user 1 and the test case T1 that are stored in the execution log, the matched container type in the use log is the Web. In another example, regarding the user 1 and the test case T2 that are stored in the execution log, the matched container type in the use log is the Web, the AP, and the DB.

In this way, the test control device 10 creates the entries in a test case-use container type table by setting, for each test case, the container type that was being used to “1” and the container type that was not being used to “0”. Furthermore, it is assumed that these test cases are not changed after this in the description here. If a test case is changed, as described above, the changed test case is handled as the test case with a new ID.

Estimation of an Exclusive Container

In the following, a description will be given of an example of estimating an exclusive container by using the test case-use container type table described above. Here, an exclusive container is estimated for each test case by sharing the containers, by changing the exclusiveness every time the test case has failed, and by repeating the test.

Specifically, the test control device 10 performs a test case by sharing all of the containers. Here, the test control device 10 waits for the second test case to be performed by a user; however, actively, the test control device 10 may also perform the test case instead of the user. Consequently, when the other test cases are simultaneously performed by the same user or a different user, there may be a state in which the containers are shared. If a certain test case fails while the test case is repeatedly performed, because the certain test case is originally supposed to be successful, it can be determined that the cause of the failure is the share of the containers.

In order to promptly detect a failure due to the share, when a test set is performed by a certain user, the tests that use the same container type in the test case-use container type table may also be positively and simultaneously performed. Then, if these tests have failed, the test control device 10 creates a success/failure table (test case success/failure table) indicating a success or a failure for each test case.

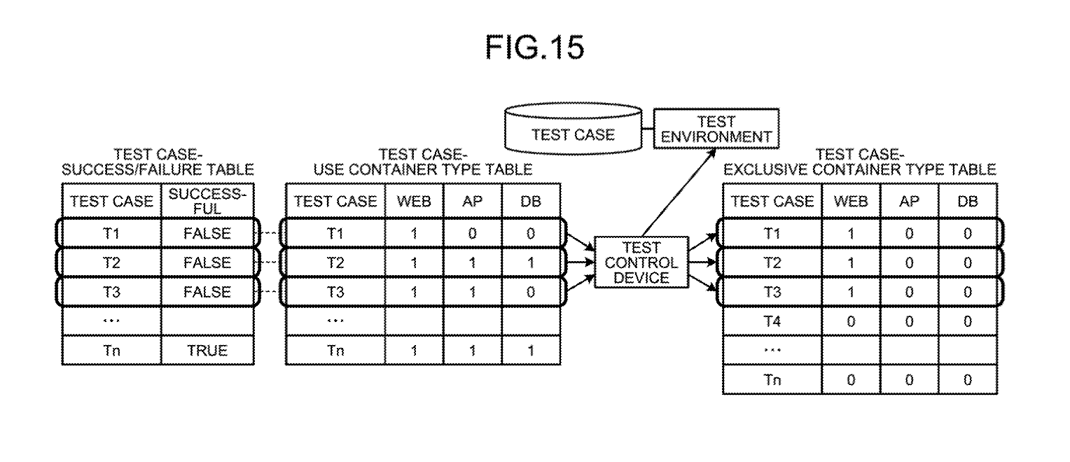

FIG. 15 is a schematic diagram illustrating estimation of the exclusive containers according to the third embodiment. As illustrated in FIG. 15, the test control device 10 acquires, for each test case that is represented by “false” in the test case success/failure table, the container type that is used in the test case-use container type table, selects a single combination, and sets the selected combination to be exclusive. For example, regarding T1, because the use container type is only the Web, the Web is selected to be an exclusive container. Regarding T2, because the use container type is all of the containers, i.e., the Web, the AP, and the DB, 2×3−1=7 cases are present. Regarding T3, because the use container type uses the Web and the AP, 2×2−1=3 cases are present. Here, in order to avoid reselecting the already selected combinations, the test control device 10 may use the selection logic having the constant selection order of the combinations or may store the already selected combinations and then select the combination other than the already selected combinations.

In this example, the test control device 10 selects the Web in any of the test cases and describes “1” in the column of the Web in the test case-exclusive container type table. Then, when a test is performed by a user, the test control device 10 describes or deletes the exclusive container information in or from the test case-exclusive container type table for each test case.

In the example illustrated in FIG. 15, when the test case-use container type table is compared with the test case success/failure table, the test control device 10 determines that the cause of the failure, such as that indicated by the test case T1, occurring even if only the Web is used is that the Web is not able to be shared. In contrast, in a case in which a plurality of container types become “1” when a test case has failed, such as that indicated by the test case T2 or T3, the test control device 10 is not able to specify the cause only from this. Thus, regarding the failed test case, the test control device 10 tests all of the exclusive combinations until no failure occurs in the test case.

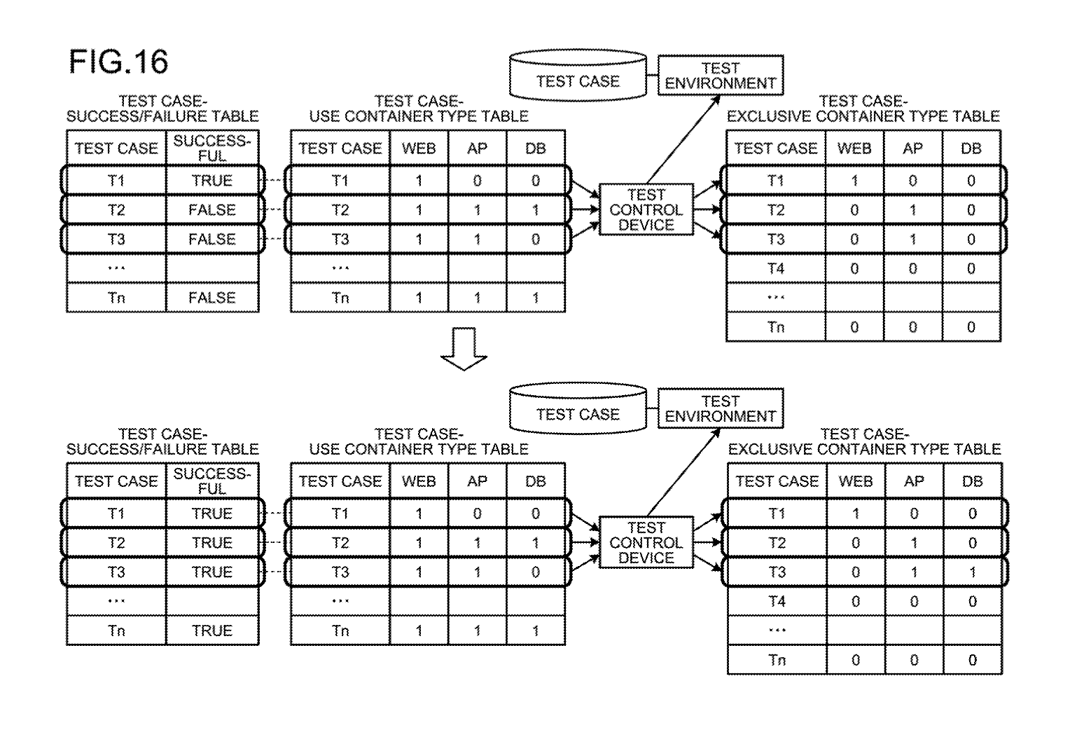

FIG. 16 is a schematic diagram illustrating estimation of the exclusive containers according to the third embodiment and continued from the estimation illustrated in FIG. 15. As indicated in the upper portion of FIG. 16, regarding the test case T1, because the test control device 10 can specify that the Web is not able to be shared, the test control device 10 decides “Web=1 (exclusiveness)” of the test case “T1” in the test case-exclusive container type table. In contrast, regarding the test cases T2 and T3, the test control device 10 performs a retest in the state in which the AP is set to “1 (exclusiveness)”.

In this way, regarding the failed test cases, the test control device 10 changes the exclusiveness and repeats the tests. Consequently, as indicated in the lower portion in FIG. 16, if the test case T2 has been successful in the exclusiveness of the AP and if the test case T3 does not fail any more in the exclusiveness of the AP and the DB, the test control device 10 can specify, in accordance with the test case-exclusive container type table in the state at that time, the exclusive container type of each of the test cases.

Flow of a Confirmation Process

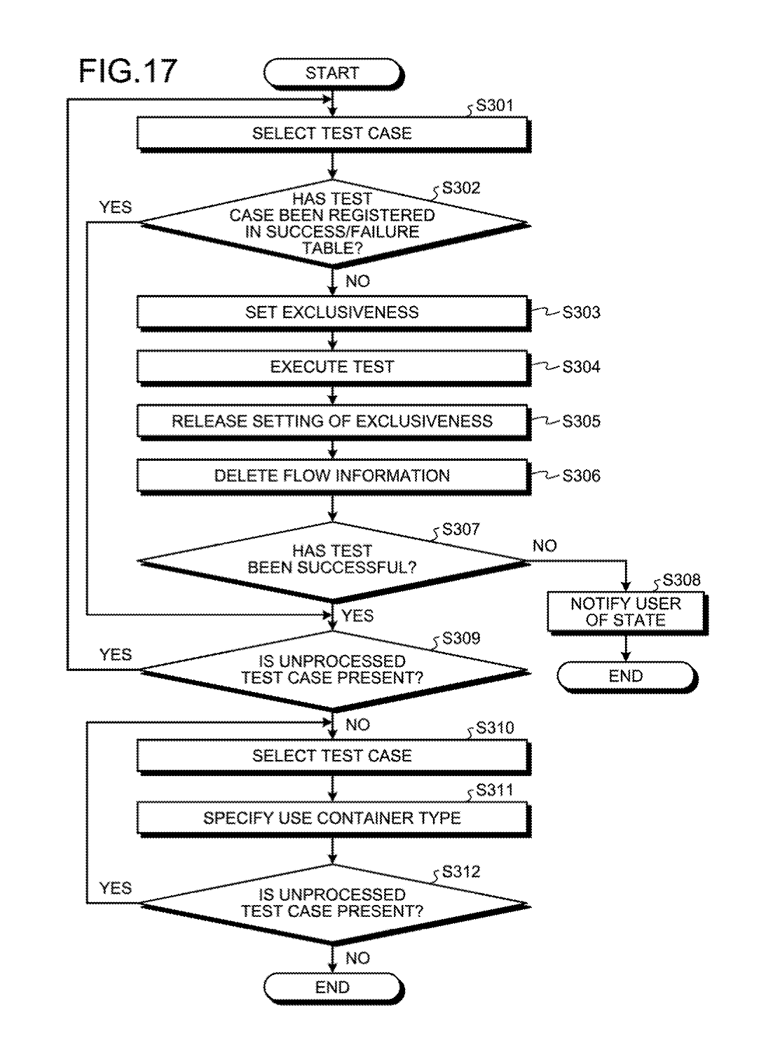

FIG. 17 is a flowchart illustrating the flow of a confirmation process of the test case according to the third embodiment. Namely, in FIG. 17, a description will be given of a process of confirming whether a test case has no problem by itself.

As illustrated in FIG. 17, when the test control device 10 starts the process, the test control device 10 selects a test case (Step S301) and determines whether the test case is registered in the success/failure table (Step S302). Then, if the test case is not registered in the success/failure table (No at Step S302), the test control device 10 sets all of the containers to the exclusiveness (Step S303) and performs the test (Step S304).

When the test has been ended, the test control device 10 releases the setting of the exclusiveness (Step S305) and deletes the flow information (Step S306). Then, if the test has failed (No at Step S307), the test control device 10 notifies the user of this state (Step S308).

In contrast, if the test has been successful (Yes at Step S307), the test control device 10 determines whether an unprocessed test case is present (Step S309). If an unprocessed test case is present (Yes at Step S309), the test control device 10 repeats the process at Step S301 and the subsequent processes. Furthermore, at Step S302, if the selected test case has been registered in the success/failure table (Yes at Step S302), the test control device 10 performs the process at Step S309.

Then, if no unprocessed test case is present (No at Step S309), the test control device 10 selects a single test case (Step S310) and specifies the use container type on the basis of the use log or the execution log (Step S311). Subsequently, if an unprocessed test case is present (Yes at Step S312), the test control device 10 repeats the process at Step S310 and the subsequent processes and, if no unprocessed test case is present (No at Step S312), the test control device 10 ends the process.

Flow of an Estimation Process

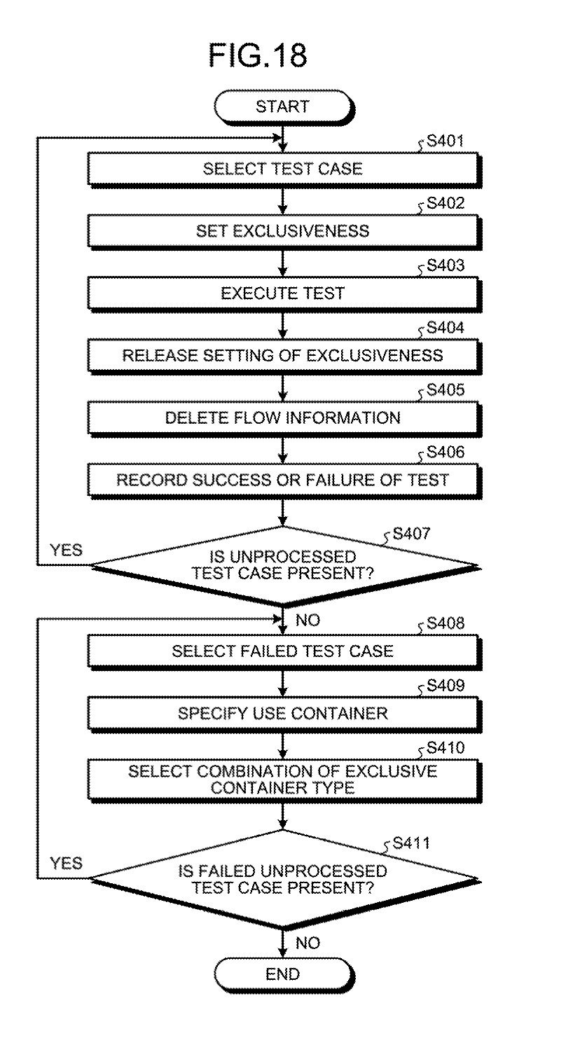

FIG. 18 is a flowchart illustrating an estimation process of the exclusive containers according to the third embodiment. As illustrated in FIG. 18, the test control device 10 selects a single test case (Step S401), sets exclusiveness to the container to be used (Step S402), and performs the test (Step S403).

Subsequently, if the performed test has been ended, the test control device 10 releases the setting of the exclusiveness (Step S404), deletes the flow information (Step S405), and records the success or failure of the test (Step S406). Here, if an unprocessed test case is present (Yes at Step S407), the process at Step S401 and the subsequent processes are repeated.

In contrast, if no unprocessed test case is present (No at Step S407), the test control device 10 selects the failed test case (Step S408) and specifies the use container that is used by the subject test case (Step S409). Subsequently, the test control device 10 selects a combination of the exclusive container type (Step S410). Then, if an unprocessed failed test case is present (Yes at Step S411), the test control device 10 repeats the process at Step S408 and the subsequent processes and, if no unprocessed failed test case is present (No at Step S411), the test control device 10 ends the process.

Effect

As described above, because the test control device 10 automatically creates the test case-exclusive container type table for each test case, a user can perform the operation with appropriate setting of the exclusiveness without setting the exclusiveness for each test case. Furthermore, because the number of shared containers is consequently increased, the reduction rate of the resources is increased.

### [d] Fourth Embodiment

In the above explanation, a description has been given of the embodiments according to the present invention; however, the present invention may also be implemented with various kinds of embodiments other than the embodiments described above.

Container

In the embodiments described above, an example of creating a test environment by using the containers has been described; however, the embodiment is not limited to this and a physical server, a virtual machine (VM), or the like may also be used.

Exclusive Information

In the embodiment, the example in which a container to be exclusively used is set in advance or estimated from a test case has been described; however, the embodiment is not limited to this. For example, a user may also embed the exclusive information in a request or may also set the exclusive information in the proxy. Specifically, the information indicating that the user 1 exclusively uses the DB and indicating that the user 2 exclusively uses both the Web and the AP may also be embedded in a Hypertext Transfer Protocol (HTTP) header or may also directly be embedded in the proxy by using the transmission source address or the like and then the transmission destination may also be controlled by the proxy in accordance with the information.

Furthermore, the test control device 10 may also automatically identify the setting as follows. For example, in the state in which the user 1 who is connecting to a certain container C, if an error or time-out occurs in a new request from the other user 2 or the other user 3, the test control device 10 estimates that the container C is exclusively used by the user 1. Such a phenomenon may possibly occur when the container C is being executed in a single thread and is subjected to step execution by the user 1 using remote debugging. Then, the test control device 10 releases the exclusive state when the connection to the user 1 has been ended.

System

Furthermore, the components of each device illustrated in FIG. 2 or 9 are not always physically configured as illustrated in the drawings. In other words, the components may also be configured by separating or integrating any of the devices. For example, the proxy execution unit 21 and the deputy processing unit 23 can be integrated. Furthermore, all or any part of the processing functions performed by each device can be implemented by a central processing unit (CPU) and by programs analyzed and executed by the CPU or implemented as hardware by wired logic.

Of the processes described in the embodiment, the whole or a part of the processes that are mentioned as being automatically performed can also be manually performed, or the whole or a part of the processes that are mentioned as being manually performed can also be automatically performed using known methods. Furthermore, the flow of the processes, the control procedures, the specific names, and the information containing various kinds of data or parameters indicated in the above specification and drawings can be arbitrarily changed unless otherwise stated.

Hardware

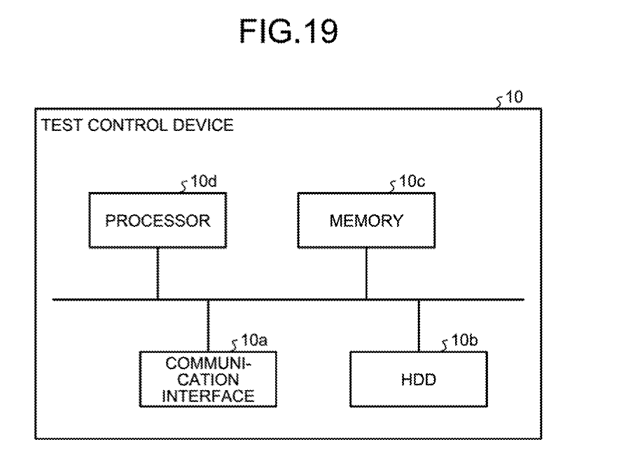

The test control device 10 described above can be implemented by, for example, a computer having the following hardware configuration. FIG. 19 is a schematic diagram illustrating an example of the hardware configuration. As illustrated in FIG. 19, the test control device 10 includes a communication interface 10a, a hard disk drive (HDD) 10b, a memory 10c, and a processor 10d.

As example of the communication interface 10a includes a network interface card or the like. The HDD 10b is a storage device that stores therein various kinds of tables illustrated in FIG. 3 or the like.

An example of the memory 10c includes a RAM, such as a synchronous dynamic random access memory (SDRAM) and the like, a read only memory (ROM), a flash memory, or the like. An example of the processor 10d includes a CPU, a digital signal processor (DSP), a field programmable gate array (FPGA), a programmable logic device (PLD), or the like.

Furthermore, by reading and executing the program, the test control device 10 is operated as an information processing apparatus that executes a test execution method. Namely, the test control device 10 executes a program that executes the same function as that performed by the proxy execution unit 21, the setting unit 22, the deputy processing unit 23, the container start-up unit 24, and the container destruction unit 25. Consequently, the test control device 10 can execute a process that executes the same process as that performed by the proxy execution unit 21, the setting unit 22, the deputy processing unit 23, the container start-up unit 24, and the container destruction unit 25. Furthermore, the program mentioned in the embodiment is not limited to be executed by the test control device 10. For example, the present invention may also be similarly used in a case in which another computer or a server executes a program or in which another computer and a server cooperatively execute the program with each other.

The program can be distributed via a network, such as the Internet. Furthermore, the program is recorded in a computer readable recording medium, such as a hard disk, a flexible disk, a CD-ROM, a magneto optical (MO) disk, a digital versatile disk (DVD), or the like and is executed by being read by the computer from the recording medium.

According to an aspect of the embodiments, it is possible to provide a highly convenient test environment in which the number of resources to be used is reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory configured to store therein, for each user who revises a system that includes a plurality of components, a use configuration table in which the type of the components that are used in revision is associated with the connection relation between the components that are used in the revision; and
a processor coupled to the memory and the processor configured to:
specify, when a request is received from a terminal device, on the basis of the use configuration table associated with the user of the terminal device, the type of the component that serves as the transfer destination of the request; and
transfer, when a server device associated with the specified type is running, the request to the server device and transfer, when the server device has not been started up, after starting up the subject server device, the request to the started up server device.

2. The information processing apparatus according to claim 1, wherein the processor is further configured to:
transfer, in a previously designated test environment, when a container associated with the specified type is running with respect to one of the users, the request to the container, and
when the container is not started up with respect to all of the users, start up the subject container in the test environment and transfer the request to the started up container.

3. The information processing apparatus according to claim 2, wherein the processor is further configured to delete, from the test environment, the container in which the request is not transferred for a predetermined time period in the test environment or the container in which the end of use is notified by the user and release a resource that was being used by the subject container.

4. The information processing apparatus according to claim 1, wherein the processor is further configured to:
determine, on the basis of the type of exclusively used component which is stored in the memory for each of the users, whether the type of the component that serves as the transfer destination of the request is targeted for exclusiveness,
transfer the request to the server device, in a previously designated test environment, when the server device is running and the server device is not exclusively used by all of the users,
when the server device has not been started up and is targeted for the exclusiveness, start up the subject server device in the test environment, transfer the request to the started up server device, and suppress the transfer of the request to the server device from another user, and
when the server device has not been started up and is not targeted for the exclusiveness, start up the subject server device in the test environment and transfer the request to the started up server device.

5. The information processing apparatus according to claim 4, wherein the processor is further configured to:
execute each of test cases for each of the users, specify the components that are to be used by the respective test cases, and create a list of use components associated with the respective test cases;
select the plurality of the test cases from each of the test cases, execute the plurality of the test cases in the state in which the components that are used by the plurality of the respective test cases are exclusively used, and create execution results; and
compare the list of the use components that are associated with the plurality of the respective test cases with the execution results, specify the component to be exclusively used for each of the plurality of the test cases, and store the specified component in the memory.

6. A test execution method comprising:
storing, in a storage unit, for each user who revises a system that includes a plurality of components, a use configuration table in which the type of components that are used in revision is associated with the connection relation between the components that are used in the revision, using a processor;
specifying, when a request is received from a terminal device, on the basis of the use configuration table associated with the user of the terminal device, the type of the component that serves as the transfer destination of the request, using the processor; and
transferring, when a server device associated with the specified type is running, the request to the server device and transferring, performed by the computer, when the server device has not been started up, after starting up the subject server device, the request to the started up server device, using the processor.

7. A non-transitory computer-readable recording medium having stored therein a test execution program that causes a computer to execute a process comprising:
storing, in a storage unit for each user who revises a system that includes a plurality of components, a use configuration table in which the type of components that are used in revision is associated with the connection relation between the components that are used in the revision;
specifying, when a request is received from a terminal device, on the basis of the use configuration table associated with the user of the terminal device, the type of the component that serves as the transfer destination of the request; and
transferring, when a server device associated with the specified type is running, the request to the server device and transferring, when the server device has not been started up, after starting up the subject server device, the request to the started up server device.
